(19) United States
(12) Patent Application Publication
(10) Pub. No.: US 2013/0099884 A1
(43) Pub. Date: Apr. 25, 2013

(54) LOW-PROFILE LARGE CURRENT INDUCTOR

(71) Applicants: Kuo-Wang Liang, Longtan Township (TW); Wen-Lang Fu, Longtan Township (TW); Mei-Chu Fan, Longtan Township (TW)

(72) Inventors: Kuo-Wang Liang, Longtan Township (TW); Wen-Lang Fu, Longtan Township (TW); Mei-Chu Fan, Longtan Township (TW)

(21) Appl. No.: 13/277,498

(22) Filed: Oct. 20, 2011

(51) Int. Cl. H01F 27/04

(52) U.S. Cl. 336/83

(57) ABSTRACT

A low-profile large current inductor includes an iron core having an expanded upper part, an expanded lower part, a core shank connected between the expanded upper part and the expanded lower part, two wire-mounting grooves extending across the bottom wall of the expanded lower part in a parallel manner and four arched notches respectively located on the expanded lower part at each of two distal ends of each of the two wire-mounting grooves, a winding wound round the core shank of the iron core with two end portions thereof respectively extended through the arched notches into the wire-mounting grooves, two flat electrodes respectively attached to the wire-mounting grooves and respectively connected with the end portions of the winding, and a magnetic coating surrounding the winding. The iron core has full round fillets in corner areas thereof for the passing of the two opposite end portions of the winding.

### BACKGROUND OF THE INVENTION

1. Field of the Invention

The present invention relates to inductor technology and more particularly, to an innovative design of low-profile large current inductor, which is practical for use in mobile electronic products.

2. Description of the Related Art

An inductor is a passive electrical component used to remove noises, suppress transient current, reduce EMI (electromagnetic interference) and convert power. Inductors are widely used in a variety of electronic products. An inductor is usually constructed as a winding of conducting material, typically copper wire, wrapped around a core for raising or lowering the voltage. For use in a mobile electronic product, such as smart cell phone, tablet PC or notebook computer that has light, thin, short and small characteristics, electronic components must be made having a low profile characteristic.

Taiwan Patent I 301989 discloses a winding component design, entitled “Surface-mounting winding component and method of producing the same”, that has a low profile and shows high reliability in different temperature environments.

According to this design, a surface-mounting choke winding 20 comprises a drum-type ferrite core 14 composed of a winding core 11 arranged with the wound axis vertically with respect to the mounting face as well as upper flange 12 and lower flange 13 formed as one body with the winding core 11 on the upper and lower ends thereof, at least one couple of core-directly attached external electrodes 15a, 15b provided on the lower surface of the lower flange 13 of the drum-type ferrite core 14, a winding 17 wound around the winding core 11 of the drum-type ferrite core 14 as well as conductively connected at its both ends to the external electrodes 15a, 15b by soldering or thermally press-attaching, and a resin coating material with magnetic powder 18 filled in the space between the upper flange 12 and the lower flange 13 of the drum-type ferrite core 14. The resin coating material with magnetic powder 18 has a glass transition temperature Tg of about −20° C. or lower, more preferably about −50° C. or lower in a course of transferring from a glass state to a rubber state during changing of shear modulus with respect to temperature as a physical property when hardening, and the thickness d of the upper flange 12 of the drum-type ferrite core is about 0.35 mm or less, and a value of a ratio L2/L1 of an outer diameter L2 of the upper flange 12 to a diameter L1 of the winding core of the drum-type ferrite core is about 1.9 or more.

In the aforesaid prior art design, a drum-type ferrite core is used and wound with a winding to form a low profile large current inductor for use in a mobile electronic device for DC/DC power supply voltage step-up/down. However, as the drum-type ferrite core has sharp edges around the periphery that may cause stress concentration, resulting in rupture of component. Further, when the lead and tail ends of the winding 17 are extended to the winding guide grooves 19 of the lower surface 13a of the lower flange 13, the lead and tail ends of the winding 17 may break easily due to concentration of stress at the corner angles of the lower flange 13. Further, the corner angles of the drum-type ferrite core 14 have rough edges or burrs and must be removed by roll grinding. However, performing roll grinding may cause a rupture in the drum-type ferrite core 14 accidentally. An improvement in this regard is necessary.

### SUMMARY OF THE INVENTION

The present invention has been accomplished under the circumstances in view. It is the main object of the present invention to provide a low-profile large current inductor, which has a low profile characteristic and eliminates the drawbacks of prior art designs.

To achieve this and other objects of the present invention, a low-profile large current inductor comprises an iron core, which comprises an expanded upper part, an expanded lower part, a core shank connected between the expanded upper part and the expanded lower part, two wire-mounting grooves extending across the bottom wall of the expanded lower part in a parallel manner, and four arched notches respectively located on the expanded lower part at each of two distal ends of each of the two wire-mounting grooves, a winding wound round the core shank of the iron core between the expanded upper part and the expanded lower part and having two end portions thereof respectively extended through the arched notches into the wire-mounting grooves, two flat electrodes respectively attached to the wire-mounting grooves and respectively connected with the end portions of the winding, and a magnetic coating surrounding the winding. The iron core comprises a plurality of full round fillets in corner areas thereof for the passing of the two opposite end portions of the winding. The periphery of the iron core is round chamfered.

Further, each wire-mounting groove defines a flat bottom surface.

Further, the expanded upper part of the iron core has the shape of an octagon. The four corners of the expanded upper part corresponding to the four arched notches have a circular arc angle. The width between opposing top and bottom sides of the octagon of the expanded upper part is shorter than the corresponding width of the expanded lower part.

Further, the two flat electrodes are made from a copper foil and configured subject to the configuration of the wire-mounting grooves for press-fitting into the wire-mounting grooves respectively. The copper foil of each flat electrode has a bottom side thereof laminated with a silver layer or coated with a layer of tin coating.

The design of the full round fillets of the iron core of the low-profile large current inductor for the passing of the two opposite end portions of the winding avoids wire breaking due to concentration of stress between the wire material of the winding and the iron core when the end portions of the winding are respectively extended out of the respective arched notches and mounted in the two wire-mounting grooves. Further, as the periphery of the iron core is round chamfered, the iron core has no burr or sharp edge and does not require any further roll grinding or surface finishing that may cause iron core damage. Further, the round chamfered periphery of the iron core avoids concentration of stress, preventing iron core rupture.

Further, the design of the flat bottom surface of each wire-mounting groove facilitates the control of the height of the product and eliminates the drawback of wire deviation of the conventional U-groove or V-groove design that affects the control of the product flatness and height.

Further, the octagonal configuration of the expanded upper part of the iron core lowers the stress concentration point of the iron core, preventing product internal crack during tin soldering.

Further, the design of the arched notches of the expanded lower part of the iron core at each of the two distal ends of each of the two wire-mounting grooves facilitates accurate mounting of the wire of the winding, preventing deviation of the wire of the winding. Further, this arched notch design enhances positioning stability of the end portions of the winding, avoiding loosening of the end portions before tin soldering.

Further, the flat electrodes are made from copper foil and configured to be press-fitted into the wire-mounting grooves, eliminating the drawback of the use of silver-plated electrodes as commonly seen in the conventional designs. Improper control of silver plating may cause defective solder fusion. Further, electroplating tends to create pollution problem. Adopting the copper foil bonding method to install the flat electrodes is environmentally friendly. Further, copper material tends to oxidize rapidly, resulting in poor soldering. Laminating the bottom surface of the copper foil of each flat electrode with a silver layer or coating it with a layer of tin coating prevents oxidization and avoiding poor soldering. Further, as the flat electrodes are configured to be press-fitted into the wire-mounting grooves, they can be positively attached to the bottom side of the iron core, avoiding falling.

### BRIEF DESCRIPTION OF THE DRAWINGS

FIG. 1 is an oblique bottom elevation view of a low-profile large current inductor in accordance with the present invention.

FIG. 2 is a bottom view of the low-profile large current inductor in accordance with the present invention.

FIG. 3 is a side view of the low-profile large current inductor in accordance with the present invention.

FIG. 4 is a sectional view taken along line A-A of FIG. 2.

FIGS. 5(A)˜5(E) are detailed plain views of the iron core of the low-profile large current inductor in accordance with the present invention.

### DETAILED DESCRIPTION OF THE PREFERRED EMBODIMENT

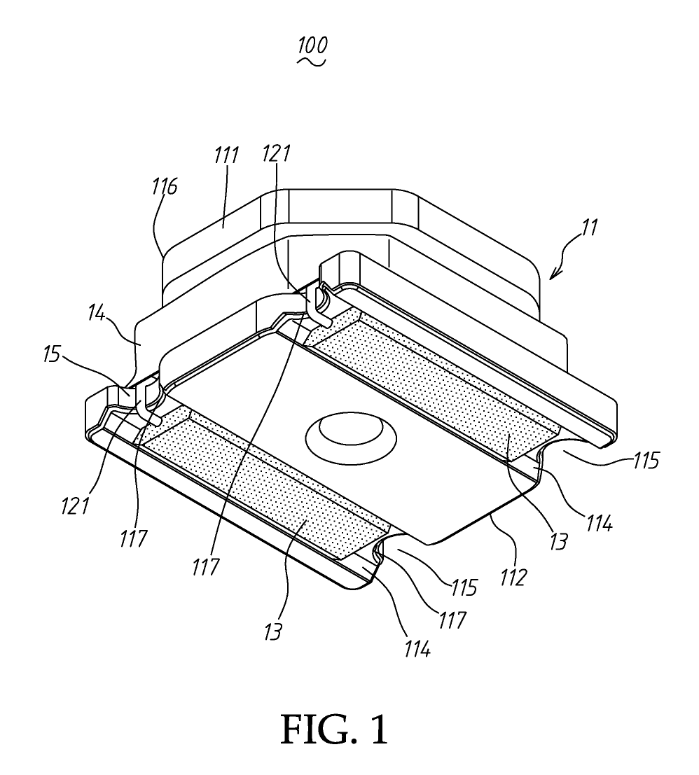

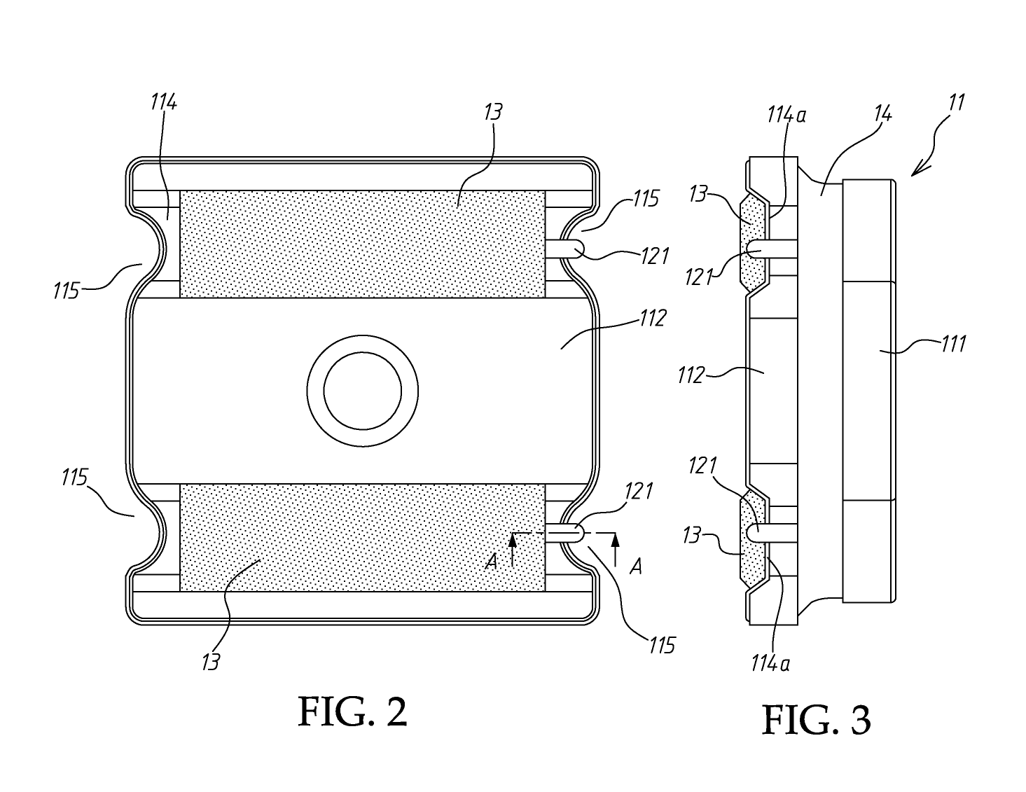

Referring to FIGS. 1˜4, a low-profile large current inductor 100 in accordance with the present invention is shown comprising an iron core 11, a winding 12, two flat electrodes 13 and a magnetic coating 14.

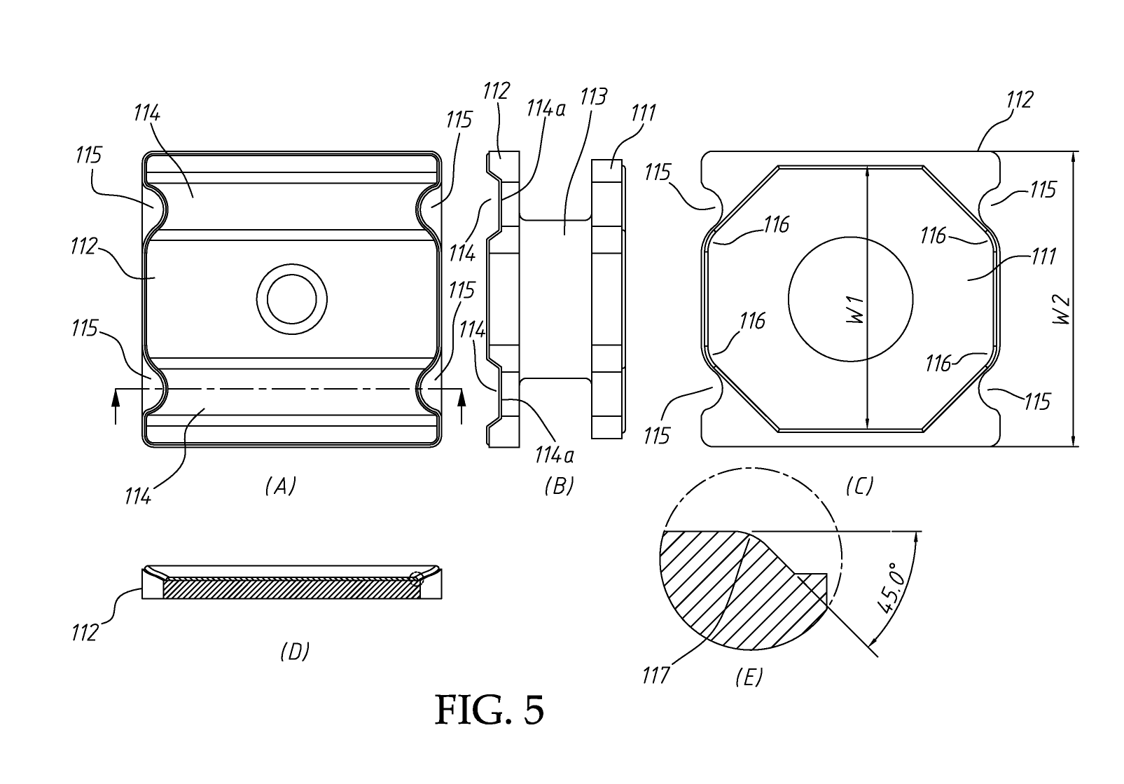

The iron core 11, as shown in FIG. 5, comprises an expanded upper part 111, an expanded lower part 112, a core shank 113 connected between the expanded upper part 111 and the expanded lower part 112, two wire-mounting grooves 114 extending across the bottom wall of the expanded lower part 112 in a parallel manner, and a plurality of arched notches 115 respectively located on the expanded lower part 112 at each of the two distal ends of each of the two wire-mounting grooves 114. Further, each wire-mounting groove 114 defines a flat bottom surface 114a, as shown in FIG. 5(B).

In this embodiment, the expanded upper part 111 of the iron core 11 has an octagonal shape, as shown in FIG. 5(C). The four corners of the expanded upper part 111 corresponding to the four arched notches 115 have a circular arc angle 116. The width W1 between the opposing top and bottom sides of the octagon of the expanded upper part 111 is shorter than the corresponding width W2 of the expanded lower part 112.

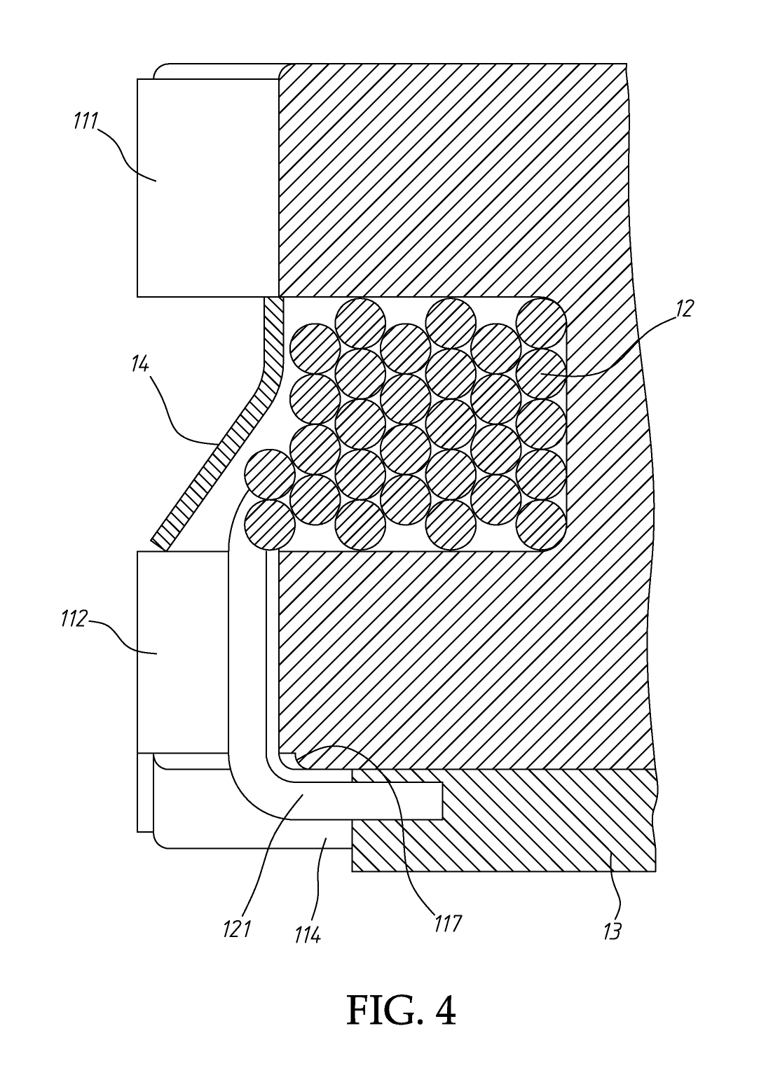

Referring to FIG. 4 and FIG. 5(E), the corner areas of the iron core 11 for the passing of the two opposite end portions 121 of the winding 12 are full round fillets 117. The periphery of the iron core 11 is also round chamfered.

As shown in FIG. 4, the winding 12 is wound round the core shank 113 of the iron core 11 between the expanded upper part 111 and the expanded lower part 112, having the two end portions 121 thereof respectively extended through the respective arched notches 115 into the wire-mounting grooves 114. The magnetic coating 14 surround the winding 12.

The two flat electrodes 13 are respectively attached to the wire-mounting grooves 114 and respectively connected with the end portions 121 of the winding 12. The two flat electrodes 13 are made from copper foil and configured to be press-fitted into the wire-mounting grooves 114 respectively, as shown in FIG. 3 and FIG. 4. Further, the bottom surface of the copper foil of each flat electrode 13 can be laminated with a silver layer or coated with a layer of tin coating.

The design of the full round fillets 117 of the iron core 11 of the low-profile large current inductor 100 for the passing of the two opposite end portions 121 of the winding 12 avoids wire breaking due to concentration of stress between the wire material of the winding 12 and the iron core 11 when the end portions 121 of the winding 12 are respectively extended out of the respective arched notches 115 and mounted in the two wire-mounting grooves 114, as shown in FIG. 4. Further, as the periphery of the iron core 11 is round chamfered, the iron core 11 has no burr or sharp edge and does not require any further roll grinding or surface finishing that may cause iron core damage. Further, the round chamfered periphery of the iron core 11 avoids concentration of stress, preventing iron core rupture.

Further, the design of the flat bottom surface 114a of each wire-mounting groove 114 facilitates the control of the height of the product and eliminates the drawback of wire deviation of the conventional U-groove or V-groove design that affects the control of the product flatness and height.

Further, the octagonal configuration of the expanded upper part 111 of the iron core 11 lowers the stress concentration point of the iron core 11, preventing product internal crack during tin soldering.

Further, the design of the arched notches 115 of the expanded lower part 112 of the iron core 11 at each of the two distal ends of each of the two wire-mounting grooves 114 facilitates accurate mounting of the wire of the winding 12, preventing deviation of the wire of the winding 12. Further, this arched notch design enhances positioning stability of the end portions 121 of the winding 12, avoiding loosening of the end portions 121 before tin soldering.

Further, as stated above, the flat electrodes 13 are made from copper foil and configured to be press-fitted into the wire-mounting grooves 114, eliminating the drawback of the use of silver-plated electrodes as commonly seen in the conventional designs. Improper control of silver plating may cause defective solder fusion. Further, electroplating tends to create pollution problem. Adopting the copper foil bonding method to install the flat electrodes 13 is environmentally friendly. Further, copper material tends to oxidize rapidly, resulting in poor soldering. Laminating the bottom surface of the copper foil of each flat electrode with a silver layer or coating it with a layer of tin coating prevents oxidization and avoiding poor soldering. Further, as the flat electrodes 13 are configured to be press-fitted into the wire-mounting grooves 114, they can be positively attached to the bottom side of the iron core 11, avoiding falling.

Although a particular embodiment of the invention has been described in detail for purposes of illustration, various modifications and enhancements may be made without departing from the spirit and scope of the invention. Accordingly, the invention is not to be limited except as by the appended claims.

1. A low-profile large current inductor, comprising:
an iron core comprising an expanded upper part, an expanded lower part, a core shank connected between said expanded upper part and said expanded lower part, two wire-mounting grooves extending across a bottom wall of said expanded lower part in a parallel manner, and four arched notches respectively located on said expanded lower part at each of two distal ends of each of said two wire-mounting grooves;
a winding wound round said core shank of said iron core between said expanded upper part and said expanded lower part, said winding comprising two opposite end portions respectively extended through said arched notches into said wire-mounting grooves;
two flat electrodes respectively attached to said wire-mounting grooves, respectively connected with said two opposite end portions of said winding, and spaced apart from corresponding notches of said four arched notches; and
a magnetic coating surrounding said winding;
wherein said iron core comprises a plurality of full round fillets located in corner areas of said four arched notches of said expanded lower part for the passing of said two opposite end portions of said winding.

2. The low-profile large current inductor as claimed in claim 1, wherein peripheries of a top surface of said expanded upper part and a bottom surface of said expanded lower part of said iron core are round chamfered.

3. The low-profile large current inductor as claimed in claim 1, wherein each said wire-mounting groove defines a flat bottom surface.

4. The low-profile large current inductor as claimed in claim 1, wherein said expanded upper part of said iron core has an octagonal shape and said expanded lower part has a rectangular shape; the four corners of said expanded upper part corresponding to the four arched notches have a circular arc angle.

5. The low-profile large current inductor as claimed in claim 4, wherein the width between opposing top and bottom sides of the octagon of said expanded upper part is shorter than the corresponding width of said expanded lower part.

6. The low-profile large current inductor as claimed in claim 1, wherein said two flat electrodes are made from a copper foil and configured subject to a configuration of said wire-mounting grooves for press-fitting into said wire-mounting grooves respectively.

7. The low-profile large current inductor as claimed in claim 6, wherein the copper foil of each said flat electrode has a bottom side thereof laminated with a silver layer or coated with a layer of tin coating.
